(19) United States
(12) Patent Application Publication
(10) Pub. No.: US 2024/0255277 A1
(43) Pub. Date: Aug. 1, 2024

(54) HANDHELD 3D SCANNER

(71) Applicant: CREAFORM INC., Levis (CA)

(72) Inventor: Nicolas Lebrun, Quebec (CA)

(21) Appl. No.: 18/569,310

(22) PCT Filed: May 6, 2022
(86) PCT No.: PCT/CA2022/050715

§ 371 Date: Dec. 12, 2023

(51) Int. Cl. G01B 11/25; H04N 13/243; H04N 23/11; H04N 23/56; H04N 23/62

(52) U.S. Cl. CPC G01B 11/254; H04N 13/243; H04N 23/11; H04N 23/56; H04N 23/62

(57) ABSTRACT

A handheld scanner is presented for generating 3D data relating to a surface of a target object. The handheld scanner comprises a frame having an outer periphery on which is mounted a set of imaging modules including at least one camera. According to some aspects, the frame has an inner periphery defining an opening at least partially enclosed by the frame and a plurality of handle regions is provided around the opening, the plurality of handle regions defining regions where the handheld scanner is holdable by a hand of a user and including at least two distinct handle regions having different orientations relative to one another and relative to the set of imaging modules. The two distinct handle regions allow a user of the scanner to easily manipulate and position in the scanner in different orientations by selectively holding the scanner using one or the other handle regions.

### TECHNICAL FIELD

The present disclosure generally relates to the field of measuring devices and methods, and, more particularly, to handheld three-dimensional (3D) scanners.

### BACKGROUND

Transportable measuring systems such as handheld scanners are used for accurately measuring 3D points on objects and recreating digital representations of 3D surfaces. For example, conventional handheld scanners comprise imaging modules, or imaging modules, such as cameras and/or a light source rigidly fixed with respect to each other (e.g., a camera stereo pair configuration), which may be used to scan objects. Specifically, scanning of a surface of an object may be achieved by moving a handheld scanner to several viewpoints of the object and capturing at each viewpoint a portion of the surface of the object with the imaging modules. The 3D measurements obtained from the different viewpoints are then combined using various techniques in order to create a digital 3D representation of the object.

Protecting the imaging modules is important as they are relatively delicate, are often some of the more costly components of the scanner and are critical in providing precise and reliable scans. As such, conventional handheld scanners are configured with a stiff construction in order to protect the imaging modules and to preserve their relative positions. To provide these characteristics, existing handheld scanners often have a bulky and heavy construction and the cost of manufacturing such handheld scanners is high. Moreover, due to their shape and weight, conventional handheld scanners have a configuration that is not easily manipulable, which renders the scanning tiresome and inefficient.

Against the background described above, it is clear that there remains a need in the industry to provide improved handheld 3D scanners that alleviate at least some of the deficiencies of conventional handheld 3D scanners.

### SUMMARY

This summary is provided to introduce a selection of concepts in a simplified form that are further described below in the Detailed Description. This Summary is not intended to identify all key aspects and/or essential aspects of the claimed subject matter.

In accordance with some general aspects of this disclosure, there is provided a handheld scanner is presented for generating 3D data relating to a surface of a target object. The handheld scanner comprises a frame on which is mounted a set of imaging modules including at least one camera. The frame has an outer periphery. The frame also has an inner periphery defining an opening at least partially enclosed by the frame and a plurality of handle regions is provided around the opening, the plurality of handle regions defining regions where the handheld scanner is holdable by a hand of a user and including at least two distinct handle regions having different orientations relative to one another and related to the set of imaging modules. The two distinct handle regions allow a user of the scanner to easily manipulate and position in the scanner in different orientations by selectively holding the scanner using one or the other handle regions.

In accordance with other general aspects of this disclosure, there is provided a handheld scanner for generating 3D data relating to a surface of a target object. The handheld scanner comprises a frame having an outer periphery on which is mounted a set of imaging modules including at least one camera. The frame has an inner periphery defining an opening at least partially enclosed by the frame. A plurality of handle regions is provided around the opening, the plurality of handle regions defining regions where the handheld scanner is holdable by a hand of a user and including at least two distinct handle regions.

In some specific implementations, each of the at least two distinct handle regions may have a different orientation relative to one another and relative to the set of imaging modules, thereby allowing a user of the scanner to position in the scanner in different orientations by selectively holding the scanner using one or the other distinct handle regions. More specifically, in use, by gripping a first of the least two distinct handle regions, a user may orient the handheld scanner in a first orientation and by gripping an other one of the least two distinct handle regions the user may orient the handheld scanner in a second orientation distinct from the first orientation.

In some specific implementations in which the inner periphery of the frame defines an opening, the opening may be configured to have different shapes.

In a first set of practical implementations, the opening defined by the inner periphery of the frame may be a generally polygonal opening and the frame may include a plurality of elongated members defining the generally polygonal opening. For example, the generally polygonal opening may have, without being limited to, a generally triangular shape, a generally trapezoidal shape, a generally hexagonal shape, a generally octagonal shape or other suitable generally polygonal shape. The outer periphery of the frame may in some implementations also have a generally polygonal shape, which may be the same or different from the shape of the opening defined by the inner periphery.

In some specific implementations, the plurality of elongated members defining the generally polygonal opening may include a main member on which is mounted the set of imaging modules and at least two elongated handle members. The plurality of elongated members may partially enclose the generally polygonal opening, leaving a gap along the inner periphery of the frame, or alternatively, the plurality of elongated members may be contiguous with one another and fully enclose the generally polygonal opening.

In some specific implementations, the at least two elongated handle members include a first handle member and a second handle member, wherein the first handle member extends from the main member at a first angle and wherein the second handle member extends from the main member at a second angle. The dimensions of the first angle and the second angle may vary between practical implementations. In addition, the first angle and the second angle may have the same size or may be different. In some specific implantations, the first angle may be between 15° and 45° and the second angle may be between 45° and 75°.

In some specific implementations, the at least two distinct handle regions may include a first handle region positioned on one of the at least two elongated handle members and a second handle region is positioned on another one of the at least two elongated handle members. In some embodiments, a third handle region may also be provided and positioned on the main member of the frame opposite the set of imaging modules.

In a second set of practical implementations, the frame may include an elongated main member on which is mounted the set of imaging modules and a curved handle member extending from the main member, wherein at least one of the at least two distinct handle regions is positioned on the curved handle member. The main member and the curved handle member may together form the opening and two of the at least two distinct handle regions may be positioned on the curved handle member. The main member and the curved handle member may at least partially enclose the opening leaving a gap along the inner periphery of the frame, or alternatively, the main member and the curved handle member may be contiguous with one another and fully enclose the opening.

In some specific implementations, the opening defined by the elongated main member and the curved handle member may form different shapes such as, for example but without being limited to, a half-moon shape.

In some specific implementations, the frame may include an elongated main member on which is mounted the set of imaging modules and two or more curved handle members, such as for example a first handle member and a second handle member. The two or more curved handle members together with the main member form the opening. The at least two distinct handle regions include a first handle region positioned on the first curved handle member and a second handle region positioned on the second curved handle member. In some embodiments, a third handle region may also be provided and positioned on the main member of the frame opposite the set of imaging modules.

In a third set of practical implementations, the frame may include an elongated main member on which is mounted the set of imaging modules and a plurality of handle members, at least one handle member extending from the elongated main member, the plurality of handle members including a curved handle member and an elongated member, wherein at least one of the at least two distinct handle regions is positioned on the curved handle member and wherein an other one of the at least two distinct handle regions is positioned one the elongated member. In some embodiments, a third handle region may also be provided and positioned on the main member of the frame opposite the set of imaging modules.

In some specific implementations, including in any of the first, second and third sets of practical implementations described above, the handheld 3D scanner may also comprise a user operable control device mounted to the frame for controlling operations of the handheld scanner. The user operable control device may be mounted to the outer periphery of the frame and may be positioned opposite to one of the at least two distinct handle regions so that, in use, the user can hold the handheld scanner by the one of the at least two distinct handle regions and access the user operable control device using a same hand. Different types of user operable control devices may be used in practical implementations, including but without being limited to, one or more of a touch-sensitive screen and a keypad including at least one electro-mechanical keys.

In some specific implementations, the set of imaging modules may comprise a pattern generator comprising a light source, the pattern generator being mounted alongside the camera. In addition, the camera may be one of a plurality of cameras mounted the frame. For example, the scanner may include a first camera and a second camera mounted to have a field of view at least partially overlapping with a field of view of the first camera. The set of imaging modules may further comprise a third camera. Different types of cameras and pattern generators may be used in practical implementations. In a very specific implementation, the light source may be an infrared light source, the first and second cameras may be infrared cameras, and the third camera may be a color camera. Other configurations for the imaging modules are possible in alternative implementations.

In some specific implementations, including in any of the first, second and third sets of practical implementations described above, the main member may be configured to define a recessed portion on the outer periphery of the frame and the set of imaging modules may be mounted in the recessed portion of the main member. A projection may be provided that at least partially surrounds the recessed portion defined by main member, the projection extending above the set of imaging modules and forming a protective bumper for the set of imaging modules. In some practical implementations, the projection may be comprised of a resilient material, such as for example but without being limited to, silicon or rubber.

In accordance with yet another general aspect of this disclosure, there is provided a handheld scanner for generating 3D data relating to a surface of a target object. The handheld scanner comprises a frame and a camera affixed to the frame. The frame comprises: a main member that is elongate and having a first end and a second end opposite the first end; a first handle member adjacent to the main member and extending near the first end of the first member and transverse to the main member; and a second handle member extending from at least one of the main member and the first handle member and oriented transverse to the first handle member. The camera is disposed on the main member of the frame. The handheld scanner is holdable by a hand of a user by one of a plurality of handle regions. The plurality of handle regions comprise at least a first handle region disposed in on the first handle member and a second handle region disposed in on the second handle member.

Advantageously, in use, by gripping a first of the least two distinct handle regions, a user may orient the handheld scanner in a first orientation and by gripping an other one of the least two distinct handle regions the user may orient the handheld scanner in a second orientation distinct from the first orientation.

In some specific implementations, the frame may have an outer periphery defined at least in part by the main member, the first handle member and second handle member, wherein the outer periphery of the frame has a generally polygonal shape. For example, the generally polygonal shape may be, without being limited to, a generally triangular shape, a generally trapezoidal shape, a generally hexagonal shape, a generally octagonal shape or any other suitable generally polygonal shape.

In some specific implementations, the frame may also have an inner periphery defining an opening at least partially enclosed by the frame. The inner periphery may be defined at least in part by the main member, the first handle member and second handle member and may be a generally polygonal opening. The general shape of the inner periphery and that of the outer periphery of the frame may be the same or may be different. For example, both the inner periphery and the outer periphery may define generally triangular shapes. Alternatively, the inner periphery may be of a generally trapezoidal shape while the outer periphery may be of a generally triangular shape.

In some specific implementations, the main member, the first handle member and second handle member may either at least partially enclose or fully enclose the generally polygonal opening.

In various practical implementations of the handheld scanners of the types described above, the handheld scanner may be equipped with the suitable hardware and software components, including one or more processors in communication with the set of imaging modules, for receiving and processing data generated by the set of imaging modules. The one or more processors may be positioned within an interior of the frame and may be operationally coupled to the set of imaging modules as well as to user controls positioned in the scanner frame. The handheld scanner may be further equipped with suitable hardware and/or software components for allowing the scanner to exchange data and control signals with external components for the purpose of controlling the scanner and/or manipulating the data collected by the scanner.

All features of exemplary embodiments which are described in this disclosure and are not mutually exclusive can be combined with one another. Elements of one embodiment or aspect can be utilized in the other embodiments/aspects without further mention. These and other aspects of this disclosure will now become apparent to those of ordinary skill in the art upon review of a description of embodiments that follows in conjunction with accompanying drawings.

### BRIEF DESCRIPTION OF THE DRAWINGS

The above-mentioned features and objects of the present disclosure will become more apparent with reference to the following description taken in conjunction with the accompanying drawings, wherein like reference numerals denote like elements and in which:

FIG. 1 is a schematic view of a handheld 3D scanner in accordance with an embodiment of the disclosure in the process of scanning a surface of a target object;

FIGS. 2 to 7B are different views of the scanner of FIG. 1 including: a perspective view (FIG. 2), a front elevation view (FIG. 3), a left side elevation view (FIG. 4), a rear elevation view (FIG. 5), a right side elevation view (FIG. 6), a top view (FIG. 7A) and a bottom view (FIG. 7B);

FIG. 8 is a left side elevation view of an interior of the scanner of FIG. 1;

FIG. 9 shows an angle between a generator direction and a first camera direction;

FIG. 10 shows an angle between the generator direction and a second camera direction;

FIG. 11 shows an angle between the first camera direction and the second camera direction;

FIG. 12 is a left side elevation view of the scanner of FIG. 1 being held by a first handle region using a first grip in accordance with an embodiment of the disclosure;

FIG. 13 is a left side elevation view of the scanner of FIG. 1 being held by a second handle region using a second grip different from the first grip shown in FIG. 12;

FIG. 14 is a left side elevation view of the scanner of FIG. 1 being held by a third handle region using a third grip different from the grips shown in FIGS. 12 and 13;

FIG. 15 is a left side elevation view of the scanner of FIG. 1 being held by a first portion of a periphery of the scanner using a fourth grip different from the grips shown in FIGS. 12 to 14;

FIG. 16 is a right side elevation view of the scanner of FIG. 1 being held in a fifth grip different from the grips shown in FIGS. 12 to 15;

FIG. 17 is a right side elevation view of the scanner of FIG. 1 being held in a sixth grip different from the grips shown in FIGS. 12 to 16;

FIG. 18 is a right side elevation view of the scanner of FIG. 1 being held in a seventh grip different from the grips shown in FIGS. 12 to 17;

FIG. 19 is a perspective view of the scanner of FIG. 1 being bisected by a plan;

FIG. 20 shows a functional block diagram of a processing system for the scanner of FIG. 1 in accordance with a specific example of implementation;

FIG. 21A shows an embodiment of an external computing device in communication with the handheld scanner of FIG. 1 in accordance with a specific example of implementation;

FIG. 21B shows an embodiment of a display device in communication with the handheld scanner of FIG. 1 in accordance with a specific example of implementation;

FIG. 22 is a rear elevation view of a handheld 3D scanner for scanning a surface of a target object, the scanner comprising a user operable control device including a keypad in accordance with an alternative example of implementation; of the handheld scanner of FIG. 1;

FIG. 23 is a left side elevation view of a handheld 3D scanner for scanning a surface of a target object, the scanner having an overall half-moon shape in accordance with a second embodiment of the disclosure;

FIG. 24 is a left side elevation view of a handheld 3D scanner for scanning a surface of a target object, the scanner having an overall crescent shape in accordance with a third embodiment of the disclosure;

FIG. 25 is a left side elevation view of a handheld 3D scanner for scanning a surface of a target object, the scanner comprising a frame structure having an inner periphery defining an opening, wherein the opening is partially enclosed by the frame leaving a gap along the inner periphery of the frame in accordance with a fourth embodiment of the disclosure;

FIG. 26 is a left side elevation view of a handheld 3D scanner for scanning a surface of a target object, the scanner comprising a frame structure having an inner periphery defining an opening, wherein the opening is partially enclosed by the frame leaving a gap along the inner periphery of the frame in accordance with a fifth embodiment of the disclosure;

FIG. 27 is a front elevation view of a handheld 3D scanner for scanning a surface of a target object in accordance with another embodiment of the disclosure;

FIG. 28 is a front elevation view of another embodiment of a handheld 3D scanner free of a pattern generator in accordance with yet another embodiment of the disclosure;

FIG. 29 is a perspective view of another embodiment of a handheld 3D scanner comprising a third handle member extending in a different plan than a main member, a first handle member and a second handle member in accordance with yet another embodiment of the disclosure;

FIG. 30 shows the handheld 3D scanner with a protective sheath covering a portion of the scanner frame in accordance with a specific embodiment of the disclosure; and

FIGS. 31 and 32 shows the handheld 3D scanner with a removeable protective lens cover module for protecting the set of imaging modules of the scanner in accordance with a specific embodiment of the disclosure.

In the drawings, embodiments are illustrated by way of example. It is to be expressly understood that the description and drawings are only for purposes of illustrating certain embodiments and are an aid for understanding. They are not intended to be a definition of the limits of the invention.

### DETAILED DESCRIPTION OF EMBODIMENTS

A detailed description of one or more specific embodiments of the invention is provided below along with accompanying Figures that illustrate principles of the invention. The invention is described in connection with such embodiments, but the invention is not limited to any specific embodiment. In particular, the present detailed description presents, amongst other, some embodiments in which the frame of the scanner has a substantially triangular outer periphery and has an inner periphery defining a substantially triangular opening wherein respective handle regions are provided around the substantially triangular opening on each of the three sides of the substantially triangular inner opening. It is to be appreciated that the embodiments described are being provided only for the purpose of illustrating the inventive principles and should not be considered as limiting. In particular, alternate embodiments will become apparent to the person skilled in the art in view of the present description, for example embodiments in which the outer periphery and/or inner periphery have a generally polygonal shape other than a generally triangular shape or a shape in which at least some of the portions are curved (rather than elongated such as, for example, a crescent shape or a half moon shape); in which the opening is partially (rather than fully) enclosed by the frame as well as other suitable alternate constructions. The scope of the invention is limited only by the claims. Numerous specific details are set forth in the following description in order to provide a thorough understanding of the invention. These details are provided for the purpose of describing non-limiting examples and the invention may be practiced according to the claims without some or all of these specific details. For the purpose of clarity, technical material that is known in the technical fields related to the invention has not been described in great detail so that the invention is not unnecessarily obscured.

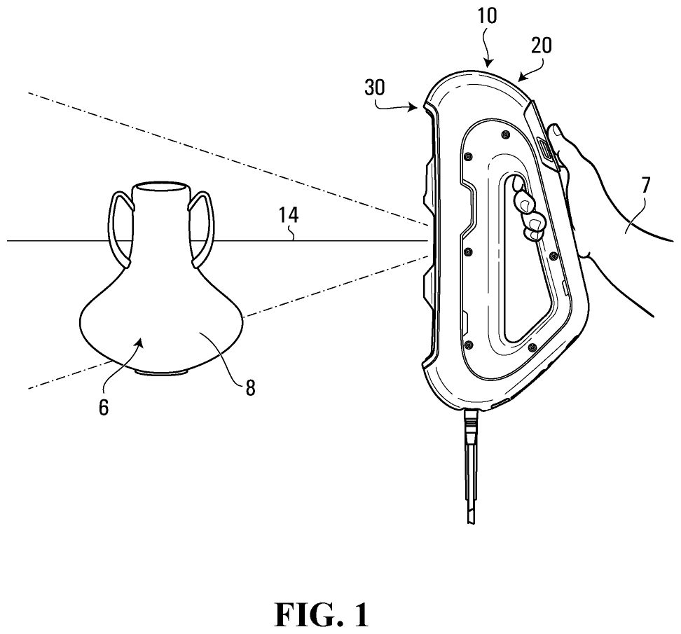

FIG. 1 shows an embodiment of a handheld scanner 10, i.e., a scanner that is holdable in one or two hands, for scanning a target object 6 and generating 3D data relating to a surface 8 of the target object 6. The scanner 10 comprises a frame structure 20 imparting stiffness to the scanner 10, and one or more imaging modules 30 affixed to the frame structure 20 for scanning the surface 8 of the target object 6. The scanner 10 also includes one or more processors (not shown in FIG. 1) positioned within an interior of the frame structure 20 and operatively connected to the one or more imaging modules 30. The one or more processors may be configured for receiving and processing data generated by the one or more imaging modules 30 during scanning. The one or more processors may also be configured for controlling the one or more imaging modules 30 to generate the data in accordance with any suitable method. Various suitable methods for controlling imaging components and for processing data generated by such components are known to persons of skill in the art and will therefore not be described in further detail here.

As depicted in FIG. 1, during use, the scanner 10 may have a scanning direction 14 and the imaging modules 30 are configured to scan surface towards the scanning direction 14.

As further described below, the frame structure 20 is ergonomically configured to facilitate its manipulation by a user and allow to easily scan a surface from different viewpoints and orientations. Advantageously, the various configurations of the frame structure presented in this disclosure may also reduce muscular fatigue, e.g., by providing a relatively high structural stiffness and by providing a scanner 10 that can more easily be manipulated and 20 positioned in different orientations without necessary requiring the user to adopt uncomfortable positions.

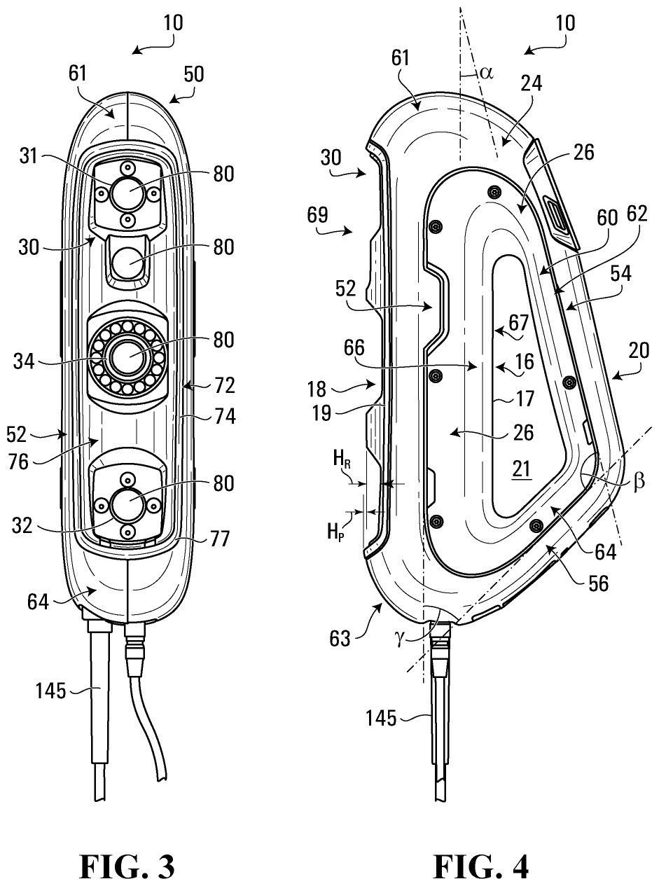

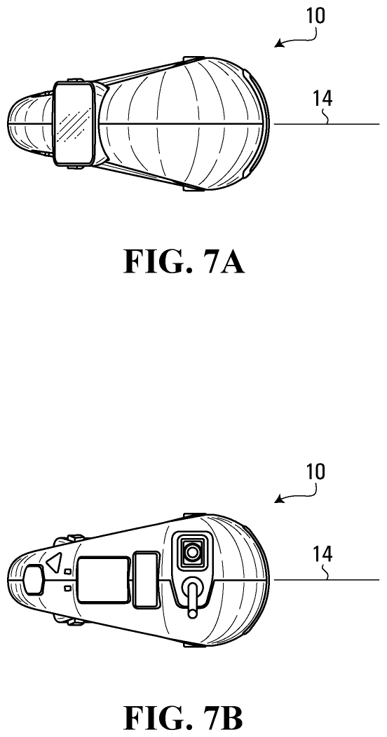

For instance, in some embodiments, the scanner 10 may have an overall shape 10 that is configured to increase a stiffness of the scanner 10 and/or facilitate manipulation of the scanner 10 by a user. The overall shape of the scanner 10 may, for example, be defined by a shape of an outer periphery 19 of the frame structure 20. The outer periphery 19 of the frame structure 20 may have any suitable overall shape, such as, for example: a generally polygonal shape (e.g. a generally triangular shape, a generally trapezoidal shape, a generally hexagonal shape, a generally octagonal shape or other generally polygonal shape etc.); a half-moon shape; a crescent shape, and the like. More particularly, in the embodiment depicted in FIGS. 1 to 16, the outer periphery 19 of the frame structure 20 has a generally triangular shape.

In the embodiment depicted in FIGS. 1 to 16, the frame structure 20 has an inner side 16 and an outer side 18. The inner side 16 may define an inner periphery 17 of the frame structure 20 and the outer side 18 may define the outer periphery 19 of the frame structure 20. More particularly, in the embodiment depicted in FIGS. 1 to 16, the inner periphery 17 defines an opening 21 on the inner side 16 of the frame structure 20. The opening 21 may in some implementations have a shape that is similar to the overall shape of the scanner 10 defined by the outer periphery 19 of the frame structure 20. In other embodiments, the opening 21 may have a shape that is different from the overall shape of the scanner 10. In practical implementations, the opening 21 may have any suitable shape, such as, for example: a generally polygonal shape (e.g. a generally triangular shape, a generally trapezoidal shape, a generally hexagonal shape, a generally octagonal shape or other generally polygonal shape etc. . . . ); a half-moon shape; a crescent shape, and the like. More particularly, in the embodiment depicted in FIGS. 1 to 16, the opening 21 defined by the inner periphery 17 of the frame structure 20 has a generally triangular shape.

In the embodiment depicted in FIGS. 1 to 16, the frame structure 20 is formed by a plurality of members 50. For instance, the members 50 of the frame structure 20 may include a main member 52, a first handle member 54 and a second handle member 56.

In this example, the main member 52 may be elongate and may comprise a first end 61 and a second end 63 opposite the first end 61. The main member 52 may comprise an inner side 67 and an outer side 69. The imaging modules 30 may be affixed to the frame structure 20 on the outer side 69 of the main member 52. The outer side 69 of the main member 52 may comprise an outer surface 71. The scanner 10 may also have one or more windows configured to cover the imaging modules 30 and forming part of the outer surface 71 of the main member 52.

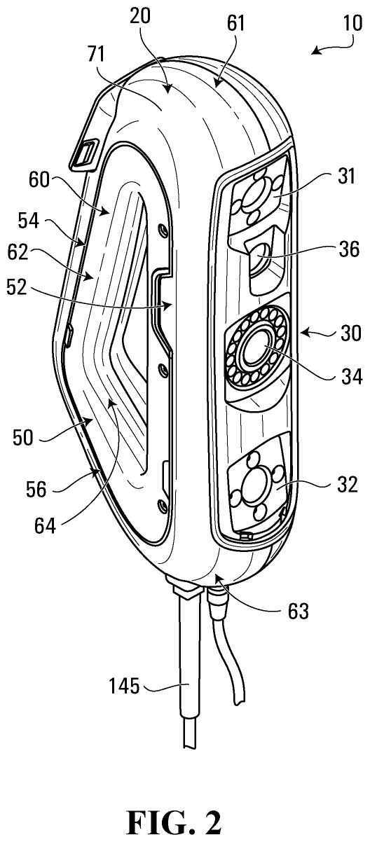

In practical implementations, the handle members 54, 56 may be configured to have different shapes. In the implementations depicted in FIGS. 2 to 16, the handle members 54, 56 are elongated members.

In the embodiment depicted in FIGS. 2 to 16, the first handle member 54 is adjacent to the main member 52 and extends from near the first end 61 of the main member 52. The first handle member 54 is also transverse to the main member 52, i.e., it extends in a direction (or has an orientation) that is different from that of the main member 52. For instance, the first handle member 54 and the main member 52 may together define an angle α (shown in FIGS. 4, 6).

Also, in this example, the second handle member 56 is adjacent the main member 52 and the first handle member 54. The second handle member 56 may extend from near the second end 63 of the main member 52. The second handle member 56 may be transverse to the first handle member 54, i.e., it extends in a direction (or has an orientation) that is different from that of the first handle member 54. For instance, the first handle member 54 and the second handle member 56 may together define an angle β (shown in FIGS. 4, 6).

As may be observed in FIGS. 4 and 6, the second handle member 56 is also transverse to the main member 52, i.e., it extends in a direction (or has an orientation) that is different from that of the main member 52. For instance, the main member 52 and the second handle member 56 may together define an angle γ.

The angles α, β and γ may have any suitable value. For instance, in some embodiments, the angle β may be larger than the angle γ, and the angle γ may be larger than the angle α. For instance, the angle α may be between 15° and 45°, the angle γ may be between 45° and 75° and the angle β may be between 75° and 105°. In some very specific embodiments, the angle α may be about 30°, the angle γ may be about 60° and the angle β may be about 90°. It is to be appreciated that while the example shown illustrate the angle γ as being larger than the angle α, in alternate embodiment angle α may be larger than angle γ. Moreover, while the examples have shown angle α and angle γ as having different values, in alternate embodiments (not shown in the figures) angle α and angle γ may have substantially similar values thereby resulting the inner periphery of the frame forming an opening having substantially isosceles triangular shape.

The members 50 of the frame structure 20 (which include main member 52 and handle member 54 and 56) are contiguous to one another and form a loop. More particularly, the main member 52 is contiguous with each of the first and second handle members 54, 56; the first handle member 54 is contiguous with each of the main member 52 and the second handle member 56; and the second handle member 56 is contiguous with each of the main member 52 and the first handle member 54.

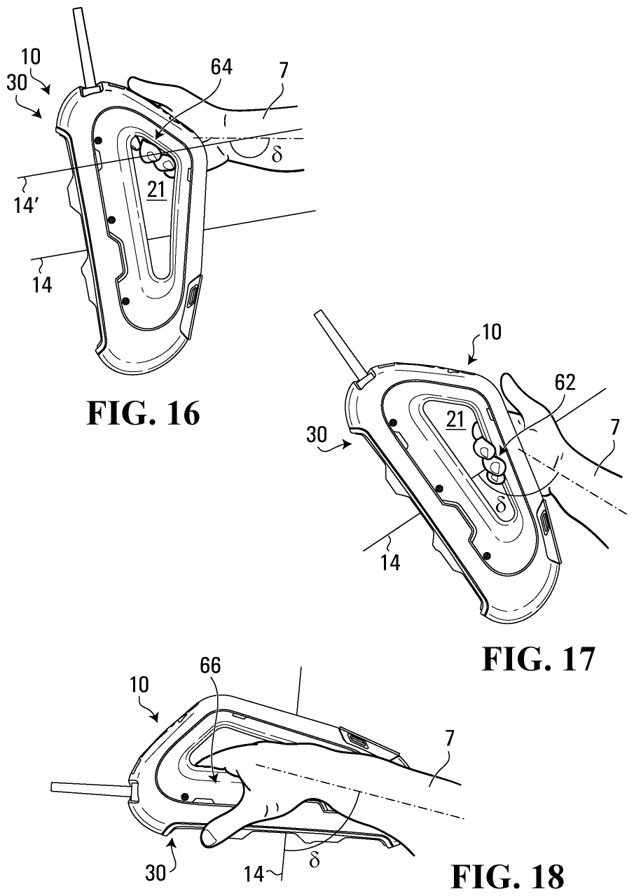

In this embodiment, as shown in FIG. 16, the members 50 are generally coplanar. That is, a single plan (2 may bisect the members 50, including the main member 52, the first handle member 54 and the second handle member 56.

With reference to FIGS. 4 and 6, the inner periphery 17 defines an opening 21 on the inner side 16 of the frame structure 20. The scanner 10 comprises a plurality of handle regions 60 are provided around the opening 21, the plurality of handle regions defining regions where the handheld scanner is configured to be holdable by a hand of a user. As such, the scanner 10 is holdable by the hand of the user by one of the handle regions 60. The handle regions 60 may comprise a first handle region 62 disposed in the first handle member 54 and a second handle region 64 disposed in the second handle member 56. In use, by gripping the first handle region 62, the user can orient the scanner 10 in a first orientation, and by gripping the second handle region 64, the user can orient the scanner 10 in a second orientation different from the first orientation.

The scanner 10 may comprise any suitable number of handle region 60. For instance, in this embodiment, the handle regions 60 further comprise a third handle region 66 disposed around the opening 21 on the main member 52. In some embodiments, the handle regions comprise at least two handle regions, in some embodiments at least three handle regions, in some embodiments four handle regions and in some embodiments even more.

More generally, an embodiment in which the internal opening defined by the inner periphery of the frame structure defines a polygonal shape of X sides (not shown in the figures), the frame may be comprised of a main member and (X−1) handle members together either partially or fully surrounding internal opening. Respective handle regions may be provided on at least two (and up to X−1) of the (X−1) handle members and optionally on the main member as well.

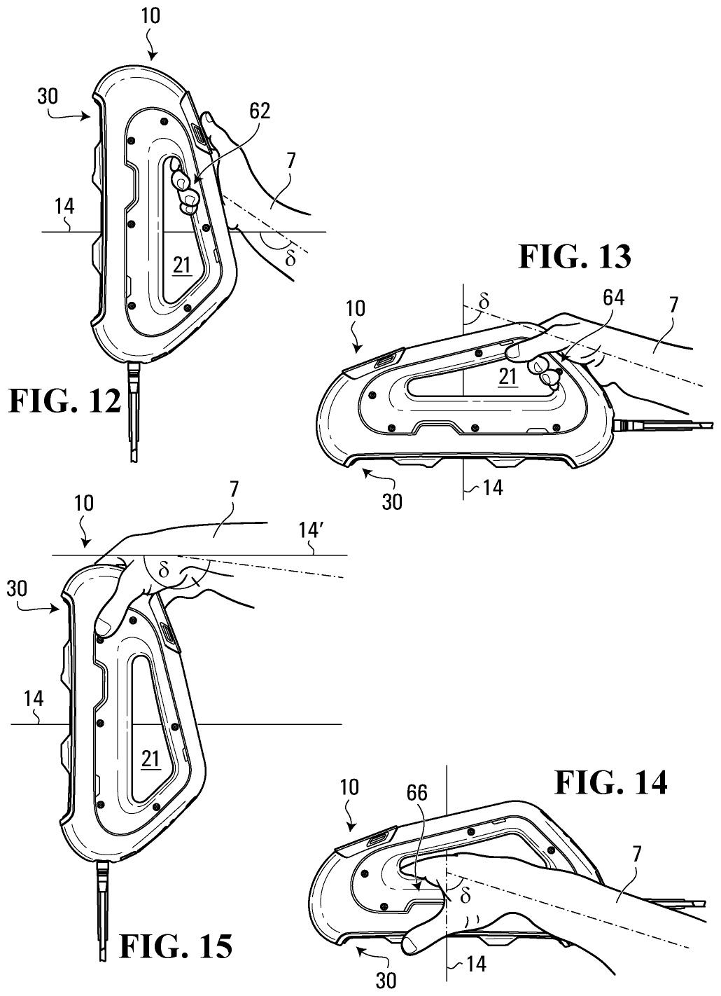

More specifically, as will be illustrated with reference to FIGS. 12 to 18, the user may hold the scanner 10 by gripping one of the handle regions 60 or by gripping one of several parts of the outer periphery of the frame structure 20. The geometry of the members 50 and the location of the regions 60 may allow the user to hold the scanner 10 using one of a plurality of grips. For instance, the user may select one of a plurality of distinct grips and hold the scanner using the selected grip. The plurality of distinct grips may comprise at least two (2) different grips, at least three (3) different grips, in some embodiments at least five (5) different grips, in some embodiments at least seven (7) different grips, and in some embodiments even more. In the embodiment depicted, the scanner includes three handle regions and the plurality of distinct grips comprises seven (7) different grips.

As a first example, a first grip is illustrated in FIG. 12. In this example, a user is holding the scanner 10 by the first handle member 54 using a grip that engages the first handle region 62 disposed in the first handle member 54. In some embodiments, the scanner 10 is configured such that an angle δ between the scanning direction 14 and a forearm 7 of the user is between 120° and 150°, in some embodiments about 135°.

As a second example, a second grip is illustrated in FIG. 13. In this example, a user is holding the scanner 10 by the second first handle member 56 using a grip that engages the second handle region 64 disposed in the second handle member 56. In some embodiments, the scanner 10 is configured such that the angle δ between the scanning direction 14 and the forearm 7 of the user is between 45° and 75°, in some embodiments about 60°.

As a third example, a third grip is illustrated in FIG. 14. In this example, a user is holding the scanner 10 by the main member 52 using a grip that engages the third handle region 66 disposed in the main member 52. In some embodiments, the scanner 10 is configured such that the angle δ between the scanning direction 14 and the forearm 7 of the user is between 60° and 90°, in some embodiments about 75°.

As a fourth example, a fourth grip is illustrated in FIG. 15. In this example, a user is holding the scanner 10 by a part of the outer periphery of the frame structure 20 last generally lies at the intersection of the main member 52 and the first handle member 56 by using a grip that engages that portion of the outer periphery of the frame structure 20. In some embodiments, the scanner 10 is configured such that the angle δ between the scanning direction 14 (or a direction 14′ parallel to the scanning direction 14) and the forearm 7 of the user is between 150° and 180°, in some embodiments about 165°.

As a fifth example, a fifth grip is illustrated in FIG. 16. In some embodiments, the scanner 10 is configured such that the angle δ between the scanning direction 14 (or the direction 14′ parallel to the scanning direction 14) and the forearm 7 of the user is between 135° and 165°, in some embodiments about 150°.

A sixth grip is illustrated in FIG. 17. In some embodiments, the scanner 10 is configured such that the angle δ between the scanning direction 14 and the forearm 7 of the user is between 90° and 120°, in some embodiments about 105°.

A seventh grip is illustrated in FIG. 18. In some embodiments, the scanner 10 is configured such that the angle δ between the scanning direction 14 and the forearm 7 of the user is between 60° and 90°, in some embodiments about 75°.

As illustrated in FIGS. 12 to 18, the user can manipulate the scanner and position it in different orientations with generally minimal displacements of the user's arm. As more particularly illustrated in FIGS. 12, 13, 14, 16, 17 and 18, the user can manipulate and position in the scanner 10 so that the scanning direction 14 is positioned in different orientations by selectively holding the scanner 10 using selected different handle regions 60. A scanner with such a configuration may render the scanning process less tiresome for the user and may lower the risk of injuries.

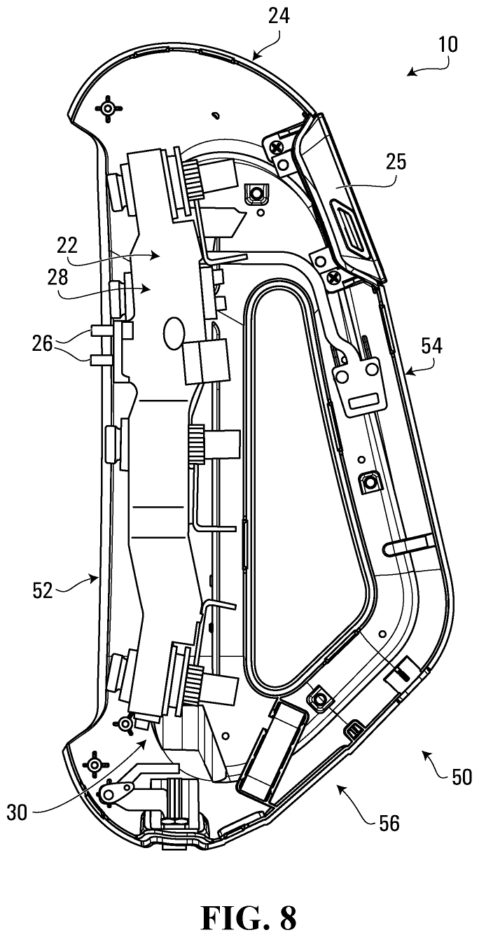

With additional reference to FIG. 8, in this embodiment, the frame structure 20 may comprise an internal frame portion 22 and an external casing portion 24 defining at least part of an exterior of the frame structure 20.

In this embodiment, the imaging modules 30 may be mounted on the internal frame portion 22 and the internal frame portion 22 may be configured to affix the imaging modules 30 in a rigid and stable fashion. In particular, the internal frame portion 22 may have a stiffness that prevents the internal frame portion 22 from deforming during use and that also prevents imaging modules 30 to move relative to one another during use, thus increasing a precision and a reliability of the data generated during the scanning.

As such, the internal frame portion 22 may be configured to impart stiffness to the frame structure 20 of the scanner 10 and may be comprised of a material that is relatively rigid. For instance, in some embodiments, a Young modulus of the material of the frame structure 20 may be at least 40 GPa, in some embodiments at least 50 GPa, in some embodiments and least 60 GPa, and in some embodiments even more (e.g., at least 69 GPa). In this embodiment, the material of the internal frame portion 22 may have a coefficient of linear thermal expansion that is relatively low. For instance, in some embodiments, the coefficient of linear thermal expansion of the material of the internal frame portion 22 may be less than 30×10⁻⁶K⁻¹, in some embodiments less than 25×10⁻⁶K⁻¹, less than 20×10⁻⁶K⁻¹, less than 15×10⁻⁶K⁻¹, and in some embodiments even less (e.g., less than 10×10⁻⁶K⁻¹). Any suitable type of material may be used to construct the internal frame portion 22 of frame structure 20, including but without being limited to metallic materials (e.g. aluminum, titanium, steel, etc.); polymeric materials; composite materials; and materials comprising glass fibers, carbon fibers and other suitable materials.

The external casing portion 24 of the frame structure 20 includes a shell that defines the overall shape of the scanner 10. The external casing portion 24 of the frame structure 20 may be hollow to allow the internal frame portion 24 to fit inside the external casing portion 24.

In this embodiment, the external casing portion 24 may be configured to shield the internal frame portion 22 and the imaging modules 30 from loads and impacts caused by environmental factors and/or events (e.g., a collision with an object, a drop of the scanner 10, etc.). In particular, the external casing portion 24 may be configured such that little to no mechanical load may be transmitted between the external casing portion 24 and the internal frame portion 22. For instance, in this embodiment, the frame structure 20 may comprise connectors 26 connecting the internal frame portion 22 to the external casing portion 24. The connectors 26 may provide a flexibility between the internal frame portion 22 and the external casing portion 24 such that when the external casing portion 24 is subject to an impact, at least part of the impact is dissipated and/or absorbed by the connectors 26 and the internal frame portion 22 is shielded from the at least part of the impact. In this embodiment, the internal frame portion 22 and the components that are rigidly affixed thereto (such as the imaging modules 30) may form an internal frame portion assembly 28. In order to shield the internal frame portion 22 and the imaging modules 30 from loads and impacts caused by environmental factors and/or events, at least part of the internal frame portion assembly 28 may be surrounded by a clearance where the internal frame portion assembly 28 is spaced from any other solid component of the scanner 10. More specifically, in this embodiment, at least a majority of the internal frame portion assembly 28 may be surrounded by the clearance. More specifically, in this embodiment, at least 90% of the internal frame portion assembly 28 may be surrounded by the clearance. More specifically, in this embodiment, at least 95% of the internal frame portion assembly 28 may be surrounded by the clearance. More specifically, in this embodiment, almost an entirety of the internal frame portion assembly 28 may be at least partly surrounded by the clearance. More specifically, in this embodiment, the entirety of the internal frame portion assembly 28 that is spaced from the connectors 26 may be surrounded by the clearance. As such, the internal frame portion assembly 28 may be viewed as “floating” in the interior of the external casing portion 24. The clearance may have any suitable dimension. For instance, in some embodiments, the clearance may be of at least 1 mm, in some embodiments of at least 2 mm, in some embodiments of at least 3 mm, and in some embodiments even more (e.g., at least 4 mm).

Another purpose of the external casing portion 24 may be to shield electronic components of the scanner 10 that may be mounted to the internal frame portion 22 and/or to an internal portion of the external casing portion 24 from environmental elements (e.g. water, dust and debris for example) that may be damaging to these components as well as to provide a package that is aesthetically pleasing and ergonomically sound for the user. The external casing portion 24 may be comprised of a material that is relatively lightweight so as not to add to the overall weight of the scanner 10. The external casing portion 24 may be comprised of a material such as, but without being limited to, a polymeric material (for e.g. a plastic). In some specific practical implementations, the polymeric material may be embedded with reinforcement fibers such as chopped fibers of another material to increase a stiffness of the casing 24. For example, the polymeric material (such as a plastic) may have therein embedded chopped fibers including glass fibers, carbon fibers or any other suitable fiber.

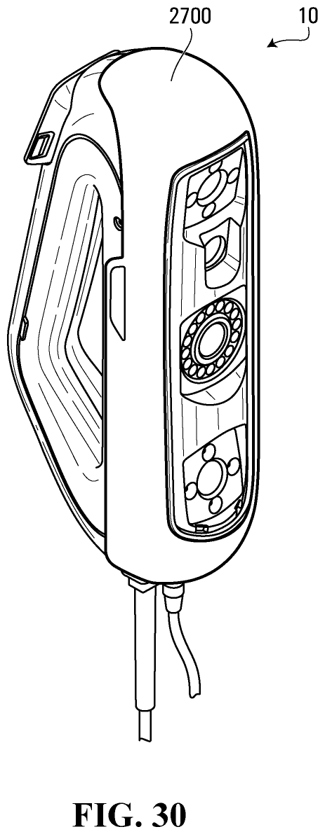

Optionally, as shown in FIG. 30, a protective sheath 2700 may be provided to cover portions of the outer surfaces the frame structure 20. In the embodiment depicted, the protective sheath 2700 is configured to cover at least a portion of the main member 52. A cut-out is provided in the protective sheath 2700 around the set of imaging modules 30 so as not to obstruct their fields of view when the protective sheath 2700 is on the scanner. It is to be appreciated that other configurations for the protective sheath 2700 may be contemplated in alternate practical implementations (not shown in the figures) including configurations that cover portions of the first handle member 54 and/or portions of second handle member 56 instead of or in addition to the portions of the main member 52. The protective sheath 2700 may be comprised of a material different from the material of the external casing portion 24 of the frame structure 20 and is preferably a material that has some level of elasticity and resiliency. In particular, the material may be flexible to that it can be placed on and removed from the outer surfaces the frame structure 20 by stretching the material. In specific examples of implementation, the protective sheath 2700 may be made of a material such as, but not being limited to, silicone and rubber.

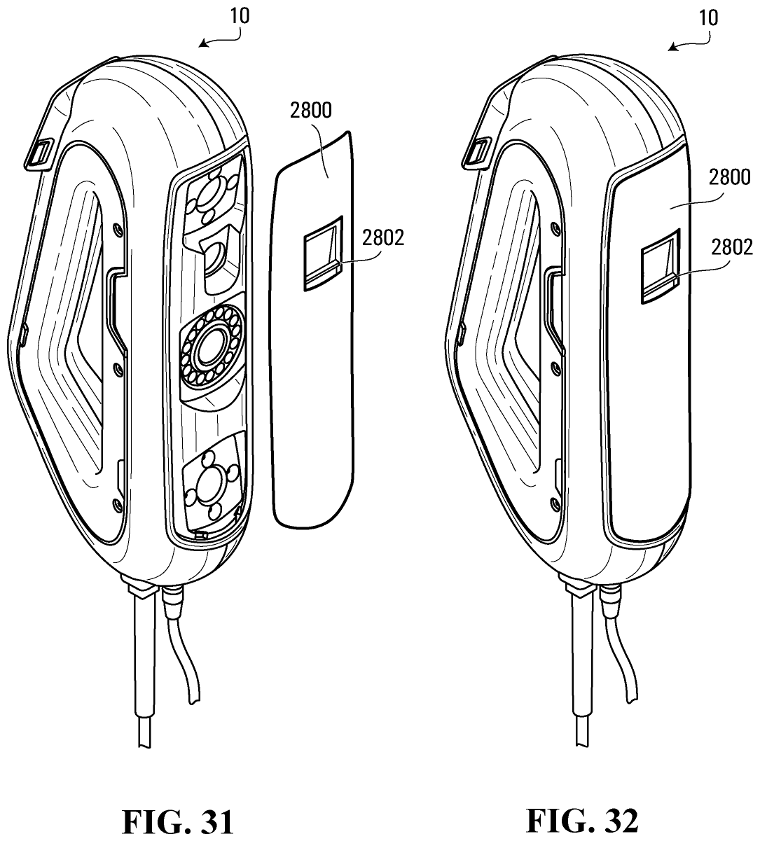

Optionally still, as shown in FIGS. 31 and 32, a removeable lens cap 2800 may be provided to cover and protect the set of imaging modules 30. The removeable lens cap 2800 is releasably fastened to be outer surface of the main member 52 using any suitable type of fastener such as one or more clips, hooks or other suitable device to secure the removeable lens cap 2800 to the main member. The fastener may be positioned about the periphery of the removeable lens cap 2800 and are configured to engage corresponding structures in the main member. The removeable lens cap 2800 is typically used when the scanner 10 is not in use to protect the set of imaging modules 30. In the embodiment depicted in FIGS. 31 and 32, the removeable lens cap 2800 includes a release actuator 2802 on its outer surface to allow a user to release the fasteners and disengage the removeable lens cap 2800 from the main member 52 of the frame structure 20. More specifically, in this embodiment, the actuator 2802 is toollessly operable (i.e. operable without requiring any tool), and more specifically, the actuator 2802 is manually operable. The removeable lens cap 2800 may be comprised of a material similar to the material of the external casing portion 24 of the frame structure 20 or may be comprised of a suitable different material. In some specific implementations, the removeable lens cap 2800 is comprised of a material that has some level of rigidity so that is better suited to protect the set of imaging modules 30. For example, the removeable lens cap 2800 may be comprised of a material such as, but without being limited to, a polymeric material (for e.g. a plastic). In some specific practical implementations, the polymeric material may be embedded with reinforcement fibers such as chopped fibers of another material to increase a stiffness of the removeable lens cap 2800. For example, the polymeric material (such as a plastic) may have therein embedded chopped fibers including glass fibers, carbon fibers or any other suitable fiber.

Returning to the embodiment depicted in FIGS. 1 to 16, as shown, the main member 52 is configured to define a recessed portion 76 on the outer periphery of the frame structure 20 and the set of imaging modules 30 is positioned within the recessed portion 76. Optionally a projection at least partially surrounds the recessed portion 76 defined by main member 52, the projection extending above the set of imaging modules 30 and forming a protective bumper 72 for the set of imaging modules. The protective bumper 72 is configured to engage a surface (such as the ground, a flat surface, etc.) and avoid contact between the surface and one of more of the imaging modules in the set of imaging modules 30 For instance, in this embodiment, the protective bumper has an overall rectangular shape which surrounds the imaging modules 30. The projection forming the protective bumper 72 may extend above the highest of the imaging modules in the set of imaging modules 30 by any suitable height Hp (shown in FIG. 4) The projection forming the protective 72 may be comprised of any suitable material such as plastic and/or a resilient material including but not limited to silicon, rubber, foam, or any other suitable material.

The recessed portion 76 defined in the main member 52 may have any suitable height HR spanning from a bottom surface of the recessed portion 76 to a base of the projection forming a protective bumper 72.

While in the embodiments described above, the set of imaging modules 30 includes at least one camera, in some practical embodiments, the scanner 10 may also include one or more additional cameras and/or one or more pattern generators, each of the one or more pattern generators including one or more light sources. The set of imaging modules 30 is mounted to the frame structure 20 and the imaging modules in the set 30 are preferably arranged alongside one another so that the field of view of at least some of the modules at least partially overlap. In the specific embodiment depicted in FIGS. 1 to 16, the set of imaging modules 30 comprises three cameras, namely a first camera 31, a second camera 32 and a third camera 34. The set of imaging modules 30 also includes a pattern generator 36 comprising a light source 38. As depicted, the imaging modules 30 are disposed alongside one another on the main member 52, and more specifically in the recess 76 defined on the main member 52.

In some specific implementations, the first and second cameras 31, 32 may be monochrome cameras. The cameras 31, 32 may be any suitable type of camera including, but no limited to monochrome or color visible spectrum and near infrared cameras. The type of cameras used for the first and second cameras will depend on the type of the light source 38 of the pattern generator 36. The cameras 31, 32 may implement any suitable shutter technology, including but not limited to: rolling shutters, global shutters, mechanical shutters and optical liquid crystal display (LCD) shutters and the like.

In some specific implementations, the third camera 34 may be a color camera (a.k.a. a texture camera). The texture camera may implement any suitable shutter technology, including but not limited to, rolling shutters, global shutters, mechanical shutters and optical LCD shutters and the like.

With reference to FIG. 6, the pattern generator 36 includes a light source 38 and is oriented in a generator direction DPG and is configured to project a pre-determined light pattern in the generator direction DPG over a field of projection FOP. For instance, the light pattern projected may be comprised of an array of generally parallel lines that a processing system (not shown in FIGS. 1 to 16) used in connection with the scanner 10 may use to reconstruct a surface based on data obtained by the first 31, second 32 and/or third 34 cameras. The use of light patterns in 3D surface reconstruction processes is beyond the scope of the present application and as such, this will not be described further here. The light source 38 may be of any suitable type and may include, without being limited to: one or more light emitting diode (LED) and one or more lasers (e.g., a VCSEL, a solid-state laser, a semiconductor laser, etc.). In some specific embodiments, the light source 38 may be configured to emit a white light; an infrared light and/or a blue light. For example, in some embodiments, the light source 38 may be configured to emit light having a wavelength between 405 nm and 940 nm.

In this embodiment, each of the imaging modules 30 may comprise a lens. As described above, the scanner 10 may also include one or more windows 80 configured to cover the imaging modules 30 and forming part of the outer surface 71 of the main member 52 of the frame structure 20. In a specific implementation of the type depicted in the Figures, individual windows 80 may be provided to cover each of the individual imaging modules 30 in these set, in this example a window 80 for each of the first camera 31, second camera 32, third camera 34 and pattern generator 36. In alternate embodiments, the scanner 10 may comprises fewer windows 80 than the number of imaging modules 30. In addition, in some alternate embodiments, at least some of the windows 80 may cover more than one of the imaging modules 30. For instance, in some embodiments, the scanner 10 may comprise a single window covering all of the imaging modules 30.

With reference more particularly to FIGS. 2 and 6, the first camera 31 is positioned on the main member 52 of the frame structure 20 and may be positioned alongside the pattern generator 36. The first camera 31 is generally oriented in a first camera direction D_{C1} and configured to have a first camera field of view FOV_{C1} at least partially overlapping with the field of projection FOP of the pattern generator 36.

The second camera 32 is also positioned on the main member 52 of the frame structure 20 and may be spaced from the first camera 31 and from the pattern generator 36. The second camera 32 is oriented in a second camera direction D_{C2} and is configured to have a second camera field of view FOV_{C2} at least partially overlapping with the field of projection FOP of the pattern generator 36 and at least partially overlapping with the first field of view FOV_{C1}.

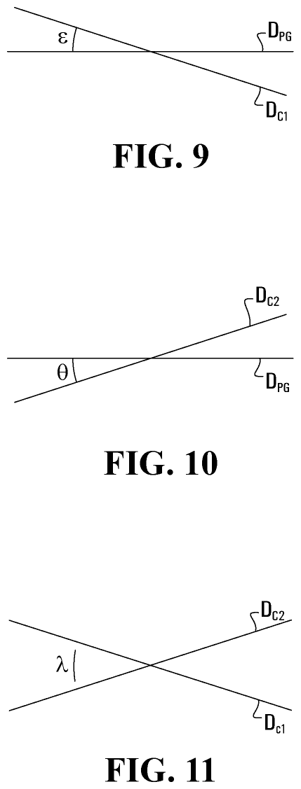

The first camera 31 may be spaced from the pattern generator 36 by any suitable distance and the first camera direction D_{C1} may be slightly angled towards the pattern generator direction DPG. For instance, in some embodiments, a distance between the pattern generator 36 and the first camera 31 may be at least 2 cm, in some embodiments at least 4 cm, in some embodiments at least 8 cm, in some embodiments at least 12 cm, and in some embodiments even more (e.g., at least 14 cm). In some embodiments, as shown in FIG. 9, an angle & between the pattern generator direction DPG and the first camera direction D_{C1} may be at least 2º, in some embodiments at least 4°, in some embodiments at least 6°, and in some embodiments even more. In other embodiments, the generator direction DPG and the first camera direction D_{C1} may be parallel to each other. In a similar fashion, in some embodiments, as shown in FIG. 10, an angle θ between the pattern generator direction DPG and the second camera direction D_{C2} may be at least 6°, in some embodiments at least 10°, in some embodiments at least 14°, and in some embodiments even more. In other embodiments, the generator direction DPG and the first camera direction D_{C2} may be parallel to each other.

The second camera 32 may be spaced from the first camera 31 by any suitable distance and the second camera direction D_{C2} may be slightly angled towards the pattern generator direction DPG and towards the first camera direction D_{C1}. For instance, in some embodiments, a distance between the first camera 31 and the second camera 32 may be at least 6 cm, in some embodiments at least 12 cm, in some embodiments at least 18 cm, and in some embodiments even more. In some embodiments, as shown in FIG. 11, an angle À between the first camera direction D_{C1} and the second camera direction D_{C2} may be at least 6°, in some embodiments at least 12°, in some embodiments at least 18°, and in some embodiments even more. In other embodiments, the first camera direction D_{C1} and the second camera direction D_{C2} may be parallel to each other.

With additional reference to FIGS. 2 and 6, the texture camera 34 is also positioned on the main member 52 of the frame structure 20 and, as depicted, may be positioned alongside the first camera 31, the second camera 32 and the pattern generator 36. The texture camera 34 is oriented in a third camera direction D_{C3} and is configured to have a third camera field of view FOV_{C3} at least partially overlapping with the field of projection FOP, with the first field of view FOV_{C1} and with the second field of view FOV_{C2}.

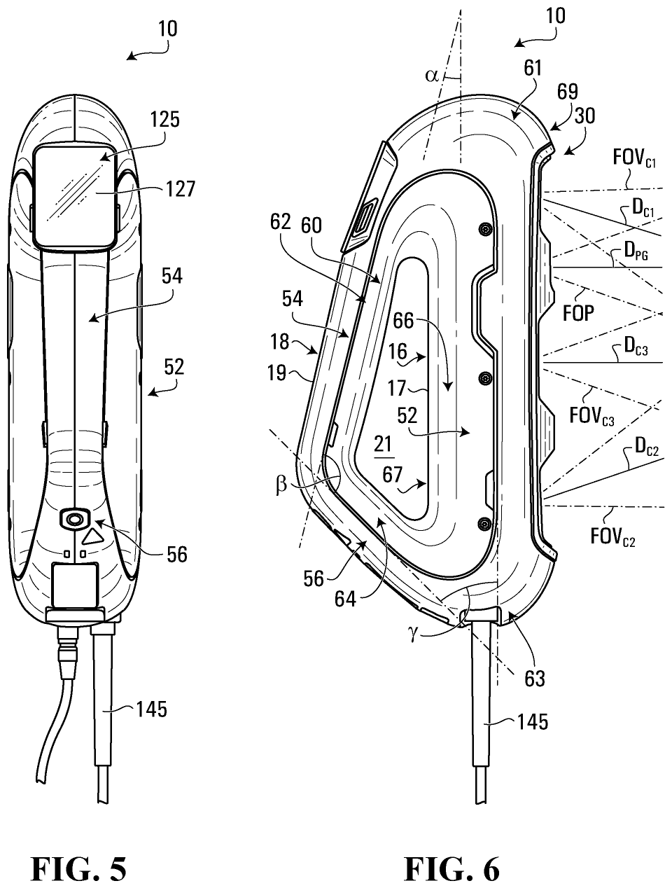

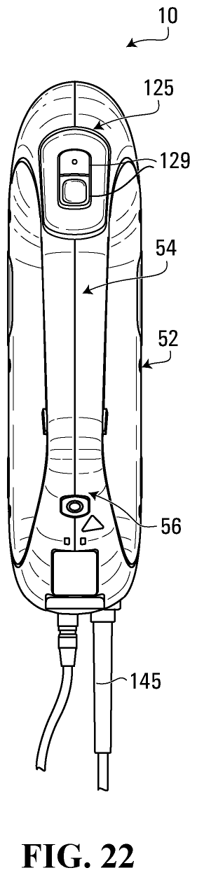

With reference to FIG. 5 and to FIG. 22, the handheld scanner 10 may in some implementations comprise a user operable control device 125 mounted to the frame structure 20 for controlling operations of the handheld scanner 10. More particularly, in this embodiment, the user operable control device 125 may be mounted to the outer periphery 19 of the frame structure 20 and may be positioned opposite to one of the at least two distinct handle regions 62, 64 so that, in use, the user can hold the scanner 10 by one of the handle regions 62, 64 and access the user operable control device 125 using a same hand. More particularly, in the embodiments depicted in FIGS. 5 and 22, the user operable control device 125 may comprises one or both of: a touch-sensitive screen 127; and a keypad 129 including at least one electro-mechanical keys.

At least part of functionality of the handheld 3D scanner 10 may be implemented by a processing system 1200. Such a processing system 1200 typically includes a processing unit 1202 (which may include one or more processors) and a memory 1204 that is connected to the processing unit 1202 by a communication bus 1208. The memory 1204 includes program instructions 1206 and data 1210. The processing unit 1202 is adapted to process the data 1210 and the program instructions 1206 in order to implement at least some of the functionality related to the handheld 3D scanner 10 including processes for generating 3D data relating to a surface of a target object. The processing system 1200 may also comprise one or more I/O interfaces for receiving or sending data elements to various modules external and internal to the handheld 3D scanner 10. In some embodiments, as depicted in FIG. 21A, the processing unit 1202 and the memory 1204 may be implemented by an external computing device 1220 configured for rendering 3D surface images based on data collected by the scanner and/or for issuing control signals to the scanner. The external computing device may be any suitable computing device such as, for example, one of: a computer, a smartphone, a laptop, a tablet computer and a phablet, on which program instructions are executed so as to process the data collected by the scanner 10 and/or issue control signals to the scanner 10. For instance, in this embodiment, the processing system 1200 may comprise an I/O interface for exchanging signal between the external computing device implementing the processing unit 1202 and the memory 1204 and the imaging modules 30 (including one or more cameras and optionally a pattern generator). In particular, the I/O interface may comprise data cables 145 connecting the external computing device with the imaging modules 30. Signals exchanged over the I/O interface between the external computing device and the imaging modules 30 may comprise, notably, image data generated by the cameras 31, 32, 34, control signals generated by the external computing device, etc. The processing system 1200 may also comprise an I/O interface for exchanging signal between the external computing device implementing the processing unit 1202 and the memory 1204 and a user operable control device (such as for example user operable control device 125 shown in FIGS. 5 and 22) mounted on the scanner 10. In particular, the I/O interface may comprise data cables 145 connecting the external computing device with the user operable control device. Signals exchanged over the I/O interface between the external computing device and the user operable control device may comprise, notably, feedback signals generated from the external computing device for communicating with the operator of the scanner 10 (e.g., via a display device, a speaker, a vibration generator, etc.), command signals generated by the user operable control device in response to user input, etc.

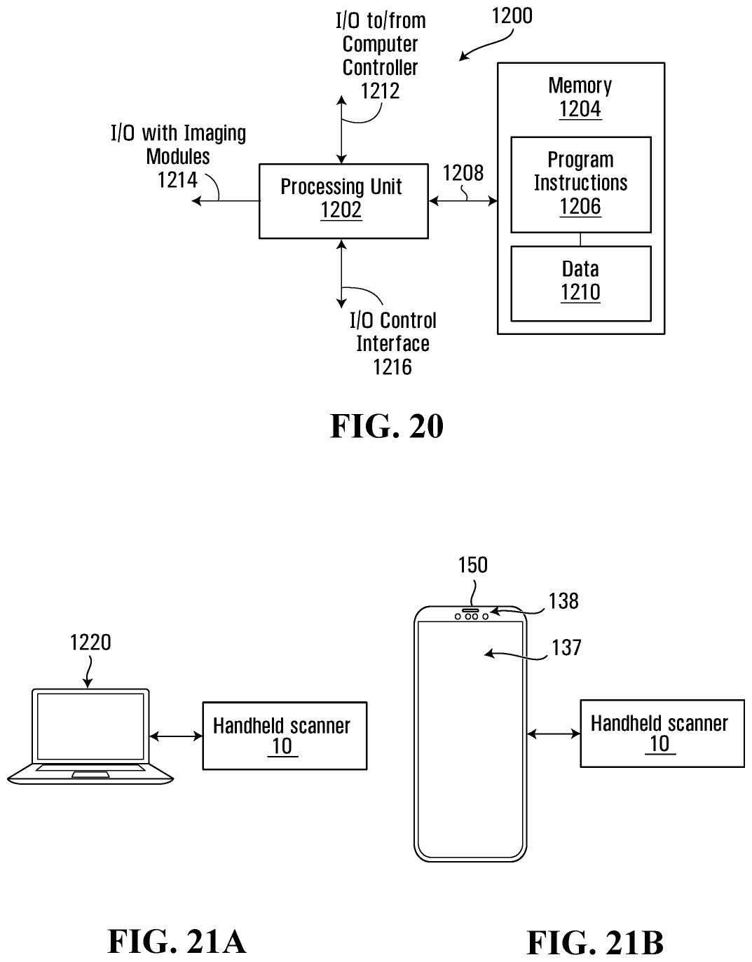

In some embodiments, as shown in FIG. 20, at least part of (i.e., part of, a majority of, or all of) the processing unit 1202 and the memory 1204 may be provided on the scanner 10. In particular, the processing system 1200 may comprise an I/O interface 1214 with the imaging modules 30 (including one or more cameras and optionally a pattern generator) and an I/O interface 1216 for exchanging signals with a user operable control device (such as for example user operable control device 125 shown in FIGS. 5 and 22) mounted to the frame structure 20 of the handheld 3D scanner 10 for receiving user inputs and conveying information to the user. In some embodiments, the processing system 1200 may also comprise an I/O interface 1212 for exchanging signals with an external computing device (not shown in the Figures) configured for rendering 3D surface images based on data collected by the scanner and/or for issuing control signals to the scanner. In some embodiments, the user operable control device may be omitted from the handheld 3D scanner 10 and the control may be provided by the external computing device via input/output device an I/O interface 1212.

In this example of implementation, the processing system 1200 may be configured for receiving image data from the cameras 31, 32, 34 (shown in FIG. 2) through I/O interface 1214, processing the image data using the processing unit 1202 to execute the program instructions 1206. The processing system 1200 may also generate and transmit signals based on the image data to an external computing device via an I/O interface 1212 for deriving and conveying, amongst other, 3D surface information to a user via a display device for example.

The display device may be part of a device separate from the scanner 10 such as for example, one of: a computer, a smartphone, a laptop, a tablet computer and a phablet, on which program instructions are executed so as to process the image data obtained by the imaging modules 30 and convey information to a user of the scanner 10.

A very specific example of a display device 150 in communication with the handheld scanner 10 is depicted in FIG. 21B. In this very specific example, this display device 150 is in the form of a smartphone programmed with suitable software for performing the desired functions. For example, the display device 150 may be programmed for example with 3D image reconstruction software and/or computer-aided design (CAD) software and be used to process the 3D data received from the handheld scanner to generate a 3D model of a surface of the target object.

The display device 150 comprises a screen 137 for displaying a user interface (e.g., a graphical user interface) for interacting with a user and a processing entity (not shown) for processing data received from the handheld scanner 10 and generating a suitable user interaction depending on the data. In this embodiment, the display device 150 also includes a speaker 138 for generated audio signals in response to certain desired events identified by the display device 150. The person skilled in the art will appreciate that various suitable computer tools and methods may be provided by the display device. Such computer tools and methods are beyond the scope of the present disclosure and will therefore not be described in further detail here.

### Alternative Configurations for Handheld Scanner

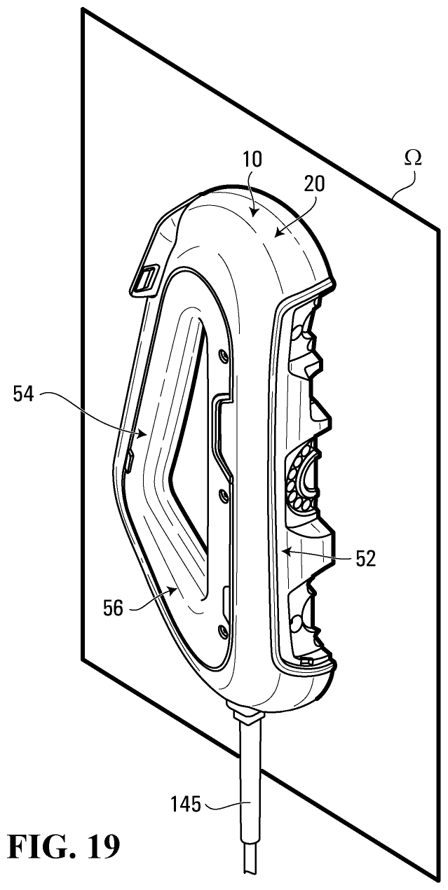

While a detailed description of an embodiment of a scanner according to the present disclosure has been presented more particularly with reference to FIGS. 1 to 21, various other embodiments of scanners may be contemplated by persons skilled in the art in view of the present disclosure.

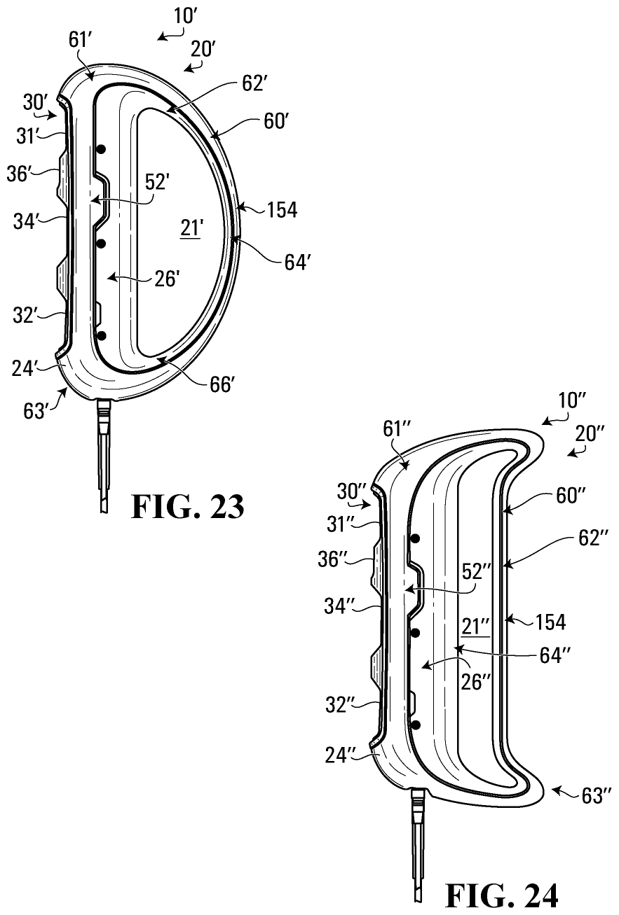

A first example of an alternative embodiment is depicted in FIG. 23. As shown, the handheld scanner 10′ may have an overall half-moon shape. In this example, the scanner 10′ comprises a curve handle member 154 and a main member 52′ (analogous to main member 52 depicted in FIG. 2) and the curved handle member 154 may at least partially enclose the opening 21′ (analogous to opening 21 in FIG. 4). In this embodiment, the main member 52′ and curved handle member 154 are contiguous with one another and fully enclose the opening 21′. More specifically, the curved handle member 154 may connect with the main member 52′ at each of the ends 61′, 63′ of the main member 52′. It is to be appreciated that in a variant of this embodiment (not shown in the Figures), the curved handle member 154 and the main member 52′ may only partially enclosed an opening formed by an inner periphery of the frame so that there is a gap along the inner periphery of the frame. The curved handle member 154 may comprise a plurality of distinct handle regions 60′ (analogous to the handle regions 60 described with reference to FIGS. 1 to 19) about the inner periphery of the frame to allow the user to orient the scanner 10′ in different orientations by gripping the scanner using different ones of the handle regions 60′.

It is to be appreciated that since in the embodiment of FIG. 23 there is in effect a single handle member 154, the different handle regions 60′ can be considered to be different portions of the curved handle member 154 that can be held by a hand of a user and that are oriented transversely to one another to permit the scanner 10′ to oriented in different orientations. For example, a first handle region may be considered to be a portion of the handle member 154 lying near end 63′ of the main member 52′ and a second handle region may be considered to be another portion of the handle member 154 lying near end 61′. In addition, yet a third handle region may be considered to be a portion of the handle member lying mid-way along the length of the handle member 15.

A second example of an alternative embodiment is depicted in FIG. 24. As shown, the handheld scanner 10″ may have an overall crescent shape. In this example, at least part of the main member 52″ (analogous to main member 52 depicted in FIG. 2) are curved near the ends 61″, 63″ of the main member 52″ and the scanner 10″ comprises a curved handle member 154′ that connects with the main member 52″ at each of the ends 61″, 63″ of the main member 52″. In this example, a first handle region 60″ may be considered to lie on the handle member 154″ and a second handle region may be consider to lie on the main member 52″.

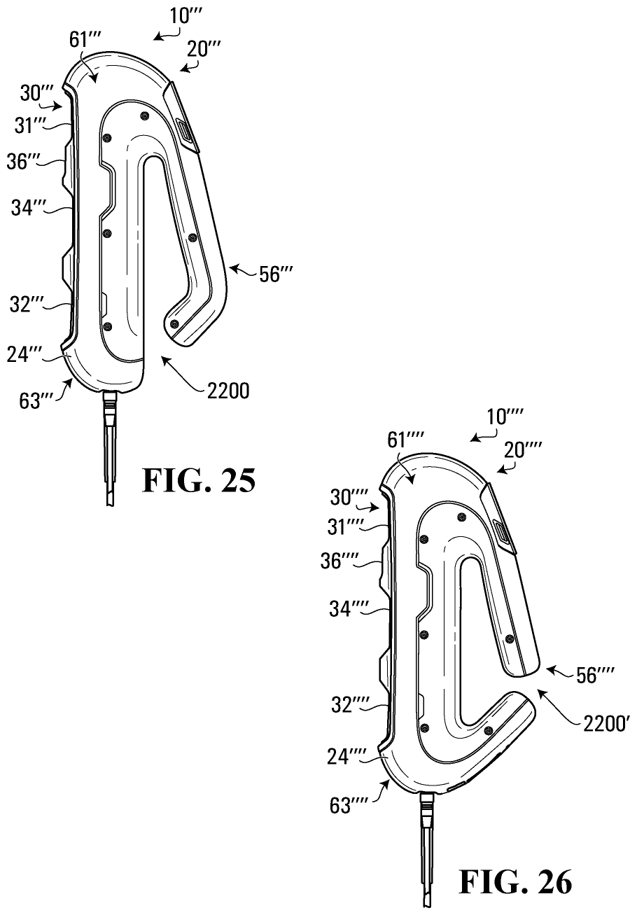

Third and fourth examples of alternative embodiments are depicted in FIGS. 25 and 26. As shown, the handheld scanners 10′″ and 10″″, the frame is formed of a plurality of elongated members including a main member and two handle members, wherein the plurality of elongated members partially enclose an opening defined by the frame so as to leave a gap 2200 and 2200′ in the inner periphery of the frame.

In addition to having different possible configurations for the frame of the scanner, yet other alternative embodiments, different types and/or number of imaging modules as part of the set of imaging modules mounted to the frame of the scanner.

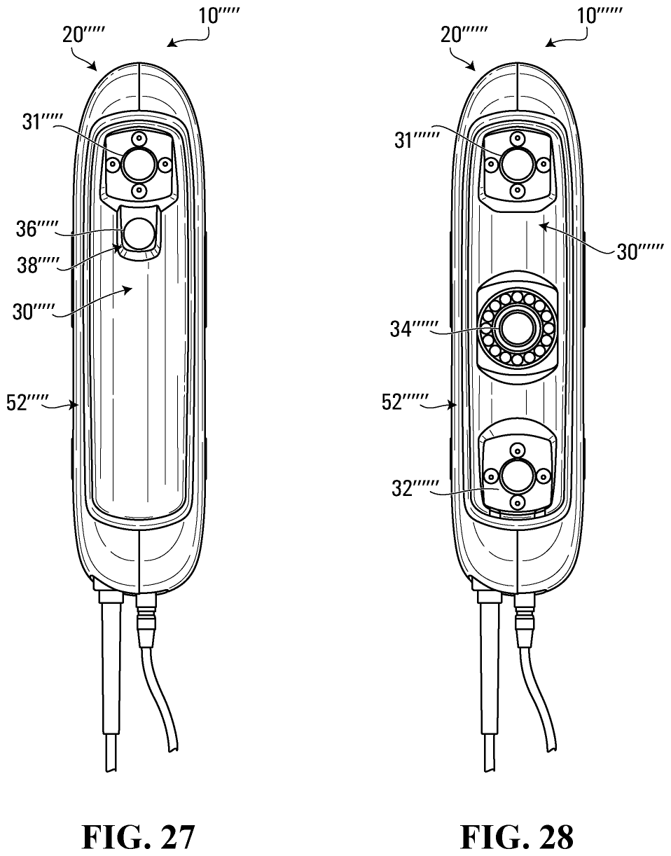

A first example of such an alternative embodiment is depicted in FIG. 27. As shown, the scanner 10″″″ has a set of imaging modules including one (1) camera 31″″″ and one pattern generator, i.e., the scanner may be free of second and third cameras.

A second example of such an alternative embodiment is depicted in FIG. 28. As shown, the scanner 10″″″ has a set of imaging modules including three (3) cameras 31″″′, 32″″, 34″″″ but no pattern generator, i.e., the scanner 10 may be free of a pattern generator.

It will be appreciated that various other suitable combinations of cameras and pattern generators may also be used as part of the set of imaging modules in alternative embodiments.

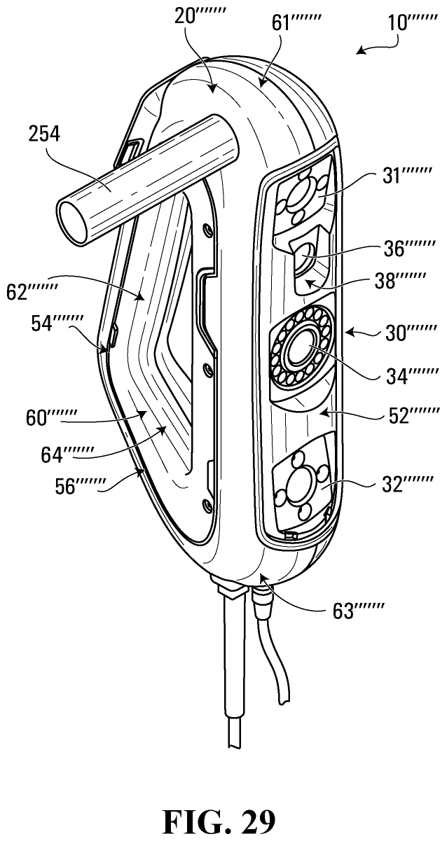

In yet another alternative to the embodiments described to date, while the embodiments have provided a frame with a main member and one or more handle members (be they elongated or curved) wherein all frame members have been substantially coplanar, in some alternate embodiments, one or more handle members lying in a different plan may be provided. In this regard, FIG. 29 shows the scanner 10 depicted in FIGS. 1 to 19 which has been constructed to add an additional handle member 254 extending on a plan different from that of the main portion 52 and the two handle portions 52 53. In this particular example, the handle member 254 extends in a direction that is generally orthogonal to the plan in which lie each of the main member 52, the first handle member 54 and the second handle member 56.

In some embodiments, any feature of any embodiment described herein may be used in combination with any feature of any other embodiment described herein.

Certain additional elements that may be needed for operation of certain embodiments have not been described or illustrated as they are assumed to be within the purview of those of ordinary skill in the art. Moreover, certain embodiments may be free of, may lack and/or may function without any element that is not specifically disclosed herein.

It will be understood by those of skill in the art that throughout the present specification, the term “a” used before a term encompasses embodiments containing one or more to what the term refers. It will also be understood by those of skill in the art that throughout the present specification, the term “comprising”, which is synonymous with “including,” “containing,” or “characterized by,” is inclusive or open-ended and does not exclude additional, un-recited elements or method steps. As used in the present disclosure, the terms “around”, “about” or “approximately” shall generally mean within the error margin generally accepted in the art. Hence, numerical quantities given herein generally include such error margin such that the terms “around”, “about” or “approximately” can be inferred if not expressly stated.

In describing embodiments, specific terminology has been resorted to for the sake of description, but this is not intended to be limited to the specific terms so selected, and it is understood that each specific term comprises all equivalents. In case of any discrepancy, inconsistency, or other difference between terms used herein and terms used in any document incorporated by reference herein, meanings of the terms used herein are to prevail and be used.

References cited throughout the specification are hereby incorporated by reference in their entirety for all purposes.

Although various embodiments of the disclosure have been described and illustrated, it will be apparent to those skilled in the art in light of the present description that numerous modifications and variations can be made. The scope of the invention is defined more particularly in the appended claims.

What is claimed is:

1.-43. (canceled)

44. A handheld scanner for generating 3D data relating to a surface of a target object, the handheld scanner comprising a frame on which is mounted a set of imaging modules including at least one camera, the frame having an outer periphery where at least part of the set of imaging modules is located, the frame having an inner periphery defining an opening at least partially enclosed by the frame, and wherein: a plurality of handle regions is provided around the opening, the plurality of handle regions including at least two distinct handle regions defining regions where the handheld scanner is configured to be held by a hand of a user; the at least two distinct handle regions having different orientations relative to one another and relative to the set of imaging modules so that, in use, by gripping a first handle region of the at least two distinct handle regions, the user orients the handheld scanner in a first orientation and, by gripping a second handle region of the at least two distinct handle regions, the user orients the handheld scanner in a second orientation distinct from the first orientation.

45. A handheld scanner as defined in claim 44, wherein the opening defined by the inner periphery of the frame is a generally polygonal opening and wherein the frame includes a plurality of elongated members defining the generally polygonal opening, the plurality of elongated members including a main member on which is mounted the set of imaging modules and at least two elongated handle members including a first elongated handle member and a second elongated handle member.

46. A handheld scanner as defined in claim 45, wherein the outer periphery of the frame has a generally polygonal shape.

47. A handheld scanner as defined in claim 45, wherein the generally polygonal opening defined by the plurality of elongated members and the outer periphery of the frame has a generally triangular shape.

48. A handheld scanner as defined in claim 45, wherein the generally polygonal opening defined by the plurality of elongated members has a generally trapezoidal shape.

49. A handheld scanner as defined in claim 45, wherein the plurality of elongated members at least partially encloses the generally polygonal opening.

50. A handheld scanner as defined in claim 45, wherein the plurality of elongated members are contiguous with one another and fully encloses the generally polygonal opening.

51. A handheld scanner as defined in claim 45, wherein the first elongated handle member extends from the main member at a first angle and wherein the second elongated handle member extends from the main member at a second angle.

52. A handheld scanner as defined in claim 51, wherein one or more of the first angle is between 15° and 45° and the second angle is between 45° and 75°.

53. A handheld scanner as defined in claim 45, wherein:
the first handle region is positioned on the first elongated handle member; and
the second handle region is positioned on the second elongated handle member.

54. A handheld scanner as defined in claim 44, wherein the frame includes an elongated main member on which is mounted the set of imaging modules and a curved handle member extending from the elongated main member, wherein at least one of the at least two distinct handle regions is positioned on the curved handle member.

55. A handheld scanner as defined in claim 54, wherein the elongated main member and the curved handle member together form the opening and wherein two of the at least two distinct handle regions are positioned on the curved handle member.

56. A handheld scanner as defined in claim 54, wherein the elongated main member and the curved handle member at least partially enclose the opening.

57. A handheld scanner as defined in claim 54, wherein the elongated main member and the curved handle member are contiguous with one another and fully enclose the opening.

58. A handheld scanner as defined in claim 54, wherein the opening defined by the elongated main member and the curved handle member has a half-moon shape.

59. A handheld scanner as defined in claim 54, wherein the curved handle member is a first curved handle member, wherein the frame includes a second curved handle member extending from the elongated main member, wherein the first and second curved handle members together with the elongated main member form the opening and wherein:
the first handle region is positioned on the first curved handle member; and
the second handle region is positioned on the second curved handle member.

60. A handheld scanner as defined in claim 45, wherein the plurality of handle regions includes a third handle region positioned on the main member of the frame.

61. A handheld scanner as defined in claim 44, further comprising a user operable control device mounted to the frame for controlling operations of the handheld scanner.

62. A handheld scanner as defined in claim 61, wherein the user operable control device is mounted to the outer periphery of the frame and is positioned opposite to one of the at least two distinct handle regions so that, in use, the user can hold the handheld scanner by the one of the at least two distinct handle regions and access the user operable control device using a same hand.

63. A handheld scanner as defined in claim 62, wherein the user operable control device includes at least one of:
a touch-sensitive screen; and
a keypad including at least one electro-mechanical keys.

64. A handheld scanner as defined in claim 44, wherein the set of imaging modules comprises a pattern generator comprising a light source, the pattern generator being mounted alongside the at least one camera on the frame.

65. A handheld scanner as defined in claim 64, wherein the at least one camera comprises a first camera and a second camera, the second camera mounted to have a field of view at least partially overlapping with a field of view of the first camera.

66. A handheld scanner as defined in claim 65, wherein the light source is an infrared light source wherein the first and second cameras are infrared cameras, and the at least one camera further comprises a third camera comprising a color camera.

67. A handheld scanner as defined in claim 45, wherein the main member is configured to define a recessed portion on the outer periphery of said frame, the set of imaging modules being mounted in the recessed portion of the main member.

68. A handheld scanner as defined in claim 67, comprising a projection at least partially surrounding the recessed portion defined by the main member, the projection extending above the set of imaging modules and forming a protective bumper for the set of imaging modules.

69. A handheld scanner as defined in claim 44, comprising one or more processors in communication with said set of imaging modules, said one or more processors being positioned within an interior of said frame and being configured for receiving data generated by said set of imaging modules.

70. A handheld scanner as defined in claim 44, wherein the different orientations of the at least two distinct handle regions are coplanar with a scanning direction of the handheld scanner.

71. A handheld scanner as defined in claim 44, wherein: the frame comprises a main member and at least one handle member, and the main member and the at least one handle member extending in different directions that are coplanar with each other and with a scanning direction of the handheld scanner.

72. A handheld scanner for generating 3D data relating to a surface of a target object, the handheld scanner comprising a frame and a camera affixed to the frame, the frame comprising:
a main member that is elongate and has a first end and a second end opposite the first end;
a first handle member adjacent to the main member and extending from near the first end of the main member, the first handle member being oriented transversely to the main member; and
a second handle member extending from at least one of the main member and the first handle member and oriented transversely to the first handle member;
wherein:
the camera is disposed on the main member of the frame;
the handheld scanner is configured to be held by a hand of a user by any one of a plurality of handle regions; and
the plurality of handle regions comprise at least a first handle region disposed in on the first handle member and a second handle region disposed in on the second handle member.

73. A handheld scanner as defined in claim 72, wherein the frame has:
an outer periphery defined at least in part by the main member, the first handle member and the second handle member, wherein the outer periphery of the frame has a generally polygonal shape; and
an inner periphery defining an opening at least partially enclosed by the frame, the inner periphery being defined at least in part by the main member, the first handle member and the second handle member.

74. A handheld scanner as defined in claim 73, wherein the opening at least partially defined by the inner periphery of the frame is a generally polygonal opening.

75. A handheld scanner as defined in claim 74, wherein the main member, the first handle member and the second handle member at least partially enclose the generally polygonal opening.

76. A handheld scanner as defined in claim 74, wherein the frame fully encloses the generally polygonal opening.

77. A handheld scanner as defined in claim 74, wherein the generally polygonal opening defined by the inner periphery of the frame and the outer periphery of the frame has a generally triangular shape.

78. A handheld scanner as defined in claim 72, wherein, in use, by gripping the first handle region, a user orients the handheld scanner in a first orientation and by gripping the second handle region, the user orients the handheld scanner in a second orientation distinct from the first orientation.

79. A handheld scanner as defined in claim 72, wherein the main member, the first handle member and the second handle member extend in different directions that are coplanar with each other and with a scanning direction of the handheld scanner.
